(19) United States
(12) Patent Application Publication
(10) Pub. No.: US 2011/0227737 A1
(43) Pub. Date: Sep. 22, 2011

(54) Physiological Sign Assessment Security Scanner System

(76) Inventor: Richard Kamins, Northridge, CA (US)

(21) Appl. No.: 12/724,521

(22) Filed: Mar. 16, 2010

(51) Int. Cl. G08B 23/00

(52) U.S. Cl. 340/573.1; 340/5.3

(57) ABSTRACT

A security system for determining if a screened individual is a potential perpetrator of a crime. The following scanning devices are connected to a scanning system control computer: a physiological sign scanning device for measuring the physiological signs of the individual, an iris scanner for scanning the individual's iris, and an identification card scanner for scanning the individual's identification. The scanning system control computer is connected to a master database located on a master computer. A predetermined set of baseline normal values of physiological signs and vital signs for the general population is installed on the master database forming a general population database. Each individual who is scanned has their own personal data file created, in which their individual physiological set of norms, plus their iris scan would be attached and compared for future scans forming an individual database. The scanning system control computer is programmed to receive scan inputs from the physiological sign scanning device, the iris scanner, and the identification card scanner and to forward the inputs to the master computer. The master computer is programmed to compare the scanned inputs to the general population database and the individual database and to assign a grade of either a pass or fail to the scanned inputs. The master computer is further programmed to transmit an alert to the scanning system control computer if the grade is a fail. After receiving an alert an operator in charge of the scanning system control computer can pull the individual aside for further investigation and screening. In a preferred embodiment, a boarding pass scanner for scanning an individual's boarding pass is also connected to the scanning system control computer. Also, in a preferred embodiment, the master database is the database of the Transportation Security Administration (TSA) and the scanning system control computer is connected to the master TSA database via the Internet.

The present invention relates to security scanning systems, and in particular to security scanning systems that measure an individual's physiological signs.

### BACKGROUND OF THE INVENTION

Terrorism is a modern worldwide concern. The time is ripe for terrorists because technology has made is easier for many terrorists to apply their trade. For example, any terrorist with access to the Internet can transmit messages of terror that impact the entire world. Likewise, a terrorist act committed in a remote corner of the world can gain worldwide attention through conventional news media. A single act of a single individual can create international fear, stress and unrest.

Specifically, we have seen in recent decades the focus on airport terrorist activity. It is hard to imagine any act more unsettling than a hijacking of a commercial airline. The memories of the 9/11 terrorist attack are still fresh in the minds of people throughout the world. As a direct result of 9/11 airport security was drastically modified. However, there are still serious problems.

The present methods of metal detectors, pat downs, K-9s, intense interviewing, and even profiling doesn't seem to totally address the problem. Presently, full body scans utilizing whole-body imaging have come to the forefront, however it has been demonstrated they can be fooled. In addition, several religious clerics have protested that the full body scan went against their religious beliefs. If only a potential perpetrator could be flushed out before they boarded a plane, or even before they reached a crowded terminal the possibilities of a terrorist threatening a plane would be very unlikely. It seems the only way to prevent there terrorists would be to read their mind. Unfortunately that is not a realizable science yet. However, it is known that people who try to deceive and who are planning to engage in terrorist or any illegal activity will more than likely be at a heightened and abnormal physiological state.

### Physiological Sensor Devices and Supporting Software

Physiological signs include the four basic vital signs (blood pressure, pulse rate, body temperature and respiratory rate) normally associated with a polygraph test. For example, other physiological signs could also include electrical impulses associated with cardiac contraction and relaxation of the individual's heart (measured by an EKG) and galvanic skin response, measured by a polygraph.

A polygraph, also referred to as a lie detector, is an instrument that measures and records several physiological responses such as blood volumes, pulse, respiration, breathing rhythms/ratios, and skin conductivity while the subject is asked and answers a series of questions, on the theory that false answers will produce physiological reactivity which can be measured. The polygraph measures physiological changes caused by the autonomic nervous system (sympathetic and parasympathetic) during questioning.

Combination physiological sensor device and supporting software packages are currently available and is currently used in healthcare, military operations, public safety organizations, and human performance such as car racing. They can monitor remotely the physiological performance of a person. By the utilization of the combination physiological sensor device, multiple physiological readings can be monitored and recorded via one device. The software package is used to interpret the data and compare it to a preset of “normal” values. If physiological readings are out of a “normal” acceptable zone, the technician administering the physiological examination is alerted, and can direct that person for more extensive investigation. One such combination physiological sensor device and supporting software package is available from Equivital, Hidalgo Ltd, with offices in Cambridge, England, model no. EQ-01.

### Iris Scan and Recording

Iris recognition is a method of biometric authentication that uses pattern-recognition techniques based on high-resolution images of the irises of an individual's eyes. Iris recognition uses camera technology, with subtle infrared illumination reducing specular reflection from the convex cornea to create images of the detail-rich, intricate structures of the iris. Converted into digital templates, these images provide mathematical representations of the iris that yield unambiguous positive identification of an individual. What is needed is a better security system for identifying potential terrorists and criminals.

### SUMMARY OF THE INVENTION

The present invention provides a security system for determining if a screened individual is a potential perpetrator of a crime. The following scanning devices are connected to a scanning system control computer: a physiological sign scanning device for measuring the physiological signs of the individual, an iris scanner for scanning the individual's iris, and an identification card scanner for scanning the individual's identification. The scanning system control computer is connected to a master database located on a master computer. A predetermined set of baseline normal values of physiological signs and vital signs for the general population is installed on the master database forming a general population database. Each individual who is scanned has their own personal data file created, in which their individual physiological set of norms, plus their iris scan would be attached and compared for future scans forming an individual database. The scanning system control computer is programmed to receive scan inputs from the physiological sign scanning device, the iris scanner, and the identification card scanner and to forward the inputs to the master computer. The master computer is programmed to compare the scanned inputs to the general population database and the individual database and to assign a grade of either a pass or fail to the scanned inputs. The master computer is further programmed to transmit an alert to the scanning system control computer if the grade is a fail. After receiving an alert an operator in charge of the scanning system control computer can pull the individual aside for further investigation and screening. In a preferred embodiment, a boarding pass scanner for scanning an individual's boarding pass is also connected to the scanning system control computer. Also, in a preferred embodiment, the master database is the database of the Transportation Security Administration (TSA) and the scanning system control computer is connected to the master TSA database via the Internet.

### BRIEF DESCRIPTION OF THE DRAWINGS

FIG. 1 shows a preferred embodiment of the present invention.

FIG. 2 shows different uses of a preferred embodiment of the present invention.

FIG. 3 shows a preferred embodiment of the present invention.

FIG. 4 shows another preferred embodiment of the present invention.

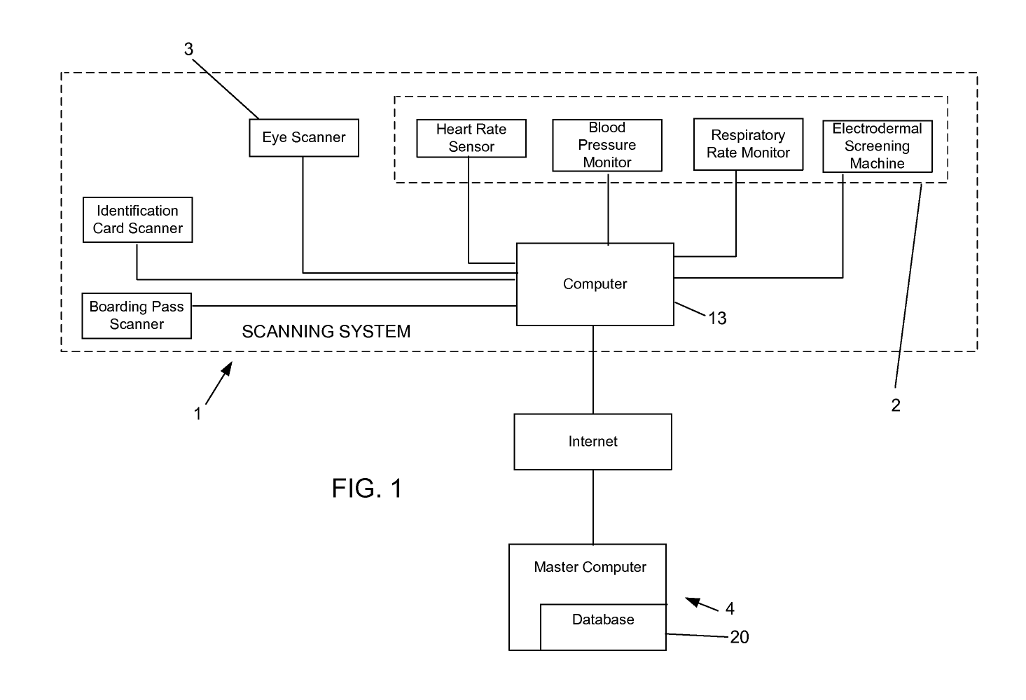

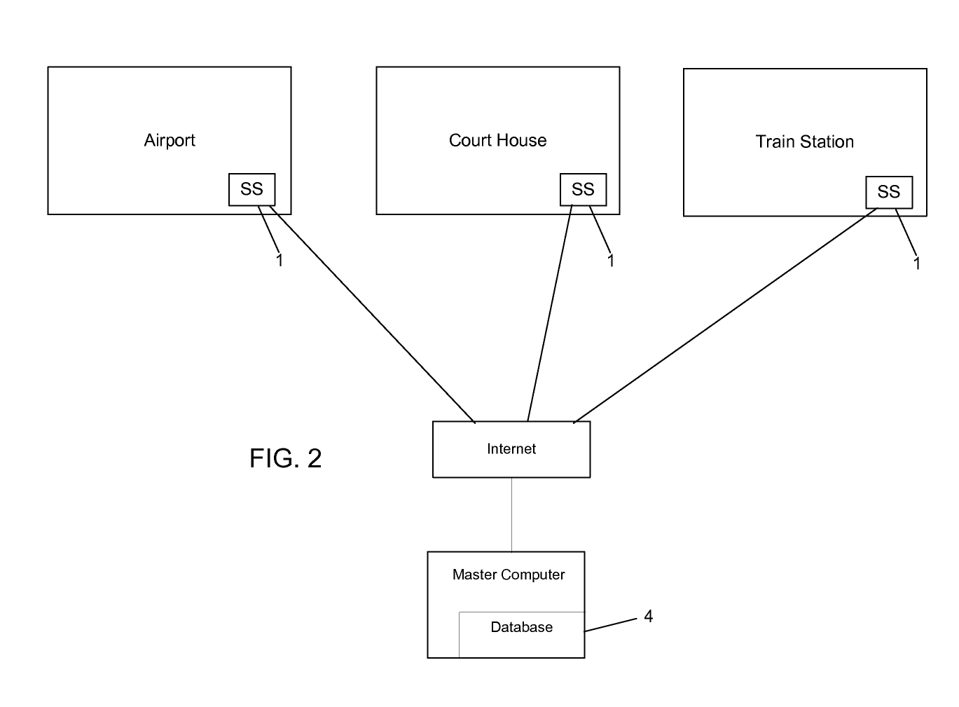

### DETAILED DESCRIPTION OF THE PREFERRED EMBODIMENTS

The present invention uses the elements of polygraph analysis to assign security risks to individuals. For example, scanning system 1 looks for heightened physiological vital signs in an individual who might be trying to perpetrate a crime. Using a combination of inputs from physiological sign sensing device 2, and iris scanner 3, each person's vital signs are taken while simultaneously an eye scan is conducted for identification purposes. The information derived from the vital sign sensing device 2 is compared with normal levels stored in database 4 and a “pass” or “fail” indication is assigned to that individual alerting whoever is in charge of the scan.

Vital sign sensing device 2 includes a series of sensors for the obtaining the vital signs of an individual. In a preferred embodiment, these vital signs include heart rate, blood pressure, respiratory rate, and electro-dermal activity. The recorded vital signs are compared to a base line standard and fluctuations are noted. If there are significant differences then a predictions is made that there is a possibility of heightened physiology attributed to deceitful activity. In a preferred embodiment, database 4 also includes data indicative of a reading profile that is consistent with abnormal or very low physiological activity due to drugs, or efforts to defraud the accuracy of the system. Any data obtained from the individual who doesn't correlate within the tolerances of the analysis program would be flagged and the operator of scanning system 1 is notified.

In addition to the vital sign scan conducted by physiological sign scanning device 2, an eye scan is conducted by iris scanner 3 and an iris print is generated. In a preferred embodiment the data of the iris print reading data and the data of the individual's vital signs sensing data are transferred from the sensing devices through the Internet to master computer 5. The data is then compiled into a central data base for future identification updating a sensory baseline.

An operator of scanning system 1 can see where there are abnormalities in an individual's identification, his boarding pass, or his physiological data. The scanned individual can then be pulled aside for further examination. In a preferred embodiment, racial profiling is not considered because the race of the individual being scanned is not determined or measured by scanning system 1.

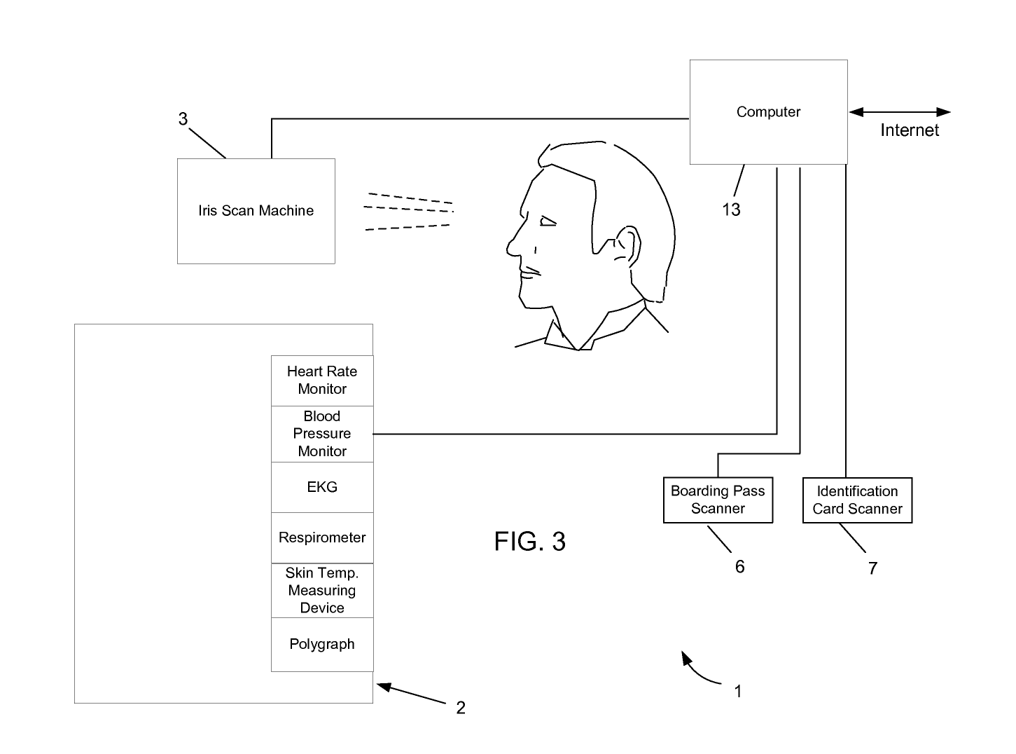

Scanning system 1 can be installed at any location where high security is needed. For example FIG. 3 show scanning system 1 installed at an airport, a court house and a train station.

### Procedure for Utilization of the Scanning System

FIG. 3 illustrates a preferred method of utilization of scanning system 1. In one example, an individual getting ready to board an airplane would be required to present his ID card and boarding pass to an operator of scanning system 1. The individual's ID card and boarding pass are scanned via boarding pass scanner 6 and ID card scanner 7.

The individual is then asked to approach physiological sign scanning device 2. In one preferred embodiment, physiological sign scanning device includes a heart rate monitor for detecting the individual's heart rate, a blood pressure monitor for detecting the individual's blood pressure, an EKG for detecting the electrical impulses associated with cardiac contraction and relaxation of the individual's heart, a respirometer for detecting the individual's respiration rate, a skin temperature measurement device for detecting the individual's skin temperature and a polygraph for detecting the individual's galvanic skin response. In a preferred embodiment, the vital sign monitoring devices are devices known in the prior art.

While the individual's vital signs are being measured by physiological sign scanning device 2, his eye is being scanned by iris scanner 3. The data from physiological sign scanning device 2, iris scanner 3, boarding pass scanner 6 and identification card scanner 7 are transferred to computer 13. Computer 13 then transfers the scans via the Internet to computer 4, as explained above.

Computer 4 is programmed to compare the data transferred from computer 13 to a baseline data profile maintained in database 20. In a preferred embodiment, it will first compare the person's physiological data to a “normal range.” If it's finds that the person's sensory data is not within the range, it will immediately alert the agent at scanning system 1. If the sensory data is within normal ranges it will check to see if there is a previous baseline file and record one if there is none. If there is already a baseline file it will compare the physiological results against the baseline and determine whether it's similar, or possibly fraudulent. It will then compare the boarding pass and identification information with the previous file and see if there are any irregularities. If computer 4 finds any irregularities it will notify the agent at scanning system 1 and identify them.

### Cuff Physiological Sign Scanner

In another preferred embodiment scan system 31 includes physiological sign scanning device 22. Physiological sign scanning device 22 includes cuff 23. Cuff 23 houses vital and physiological sign sensors within the cuff. In a preferred embodiment, the vital sign scanners in cuff 23 are: a heart rate monitor for detecting the individual's heart rate, a blood pressure monitor for detecting the individual's blood pressure, an EKG for detecting the electrical impulses associated with cardiac contraction and relaxation of the individual's heart, a respirometer for detecting the individual's respiration rate, a skin temperature measurement device for detecting the individual's skin temperature and a polygraph for detecting the individual's galvanic skin response. Cuff 23 will incorporate a custom array of sensors similar to the ones manufactured by Equivital discussed in the Background section.

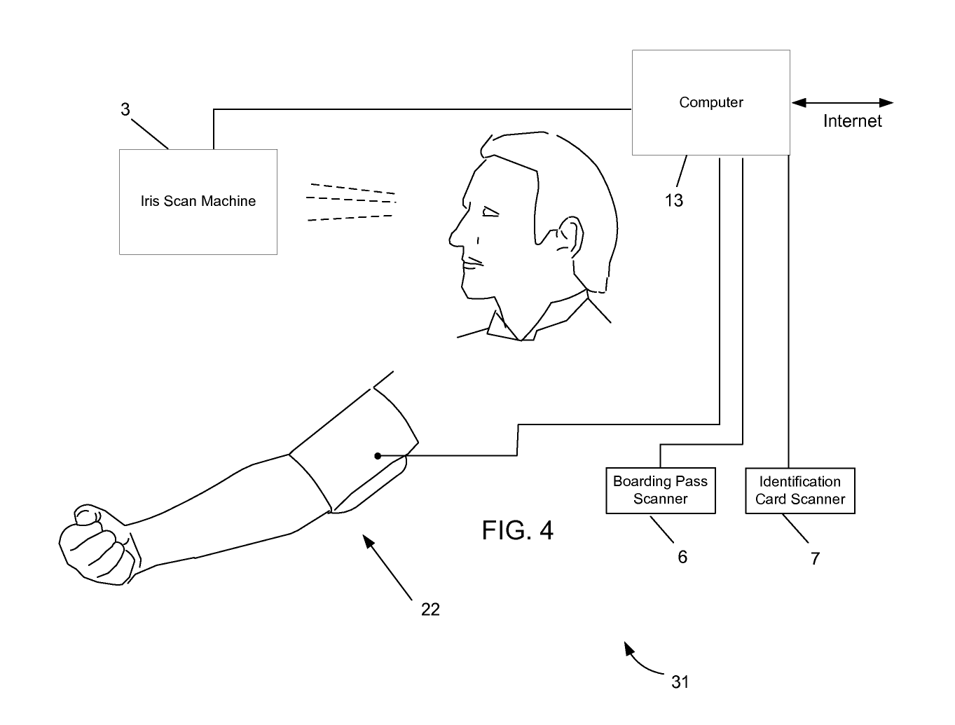

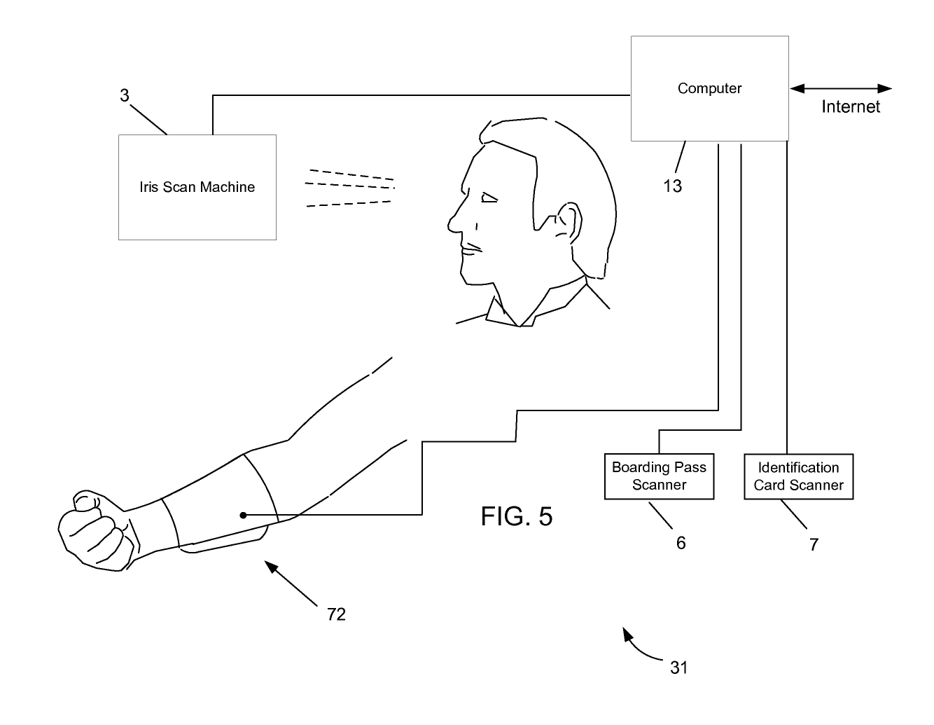

In the embodiment shown in FIG. 4, the individual is asked to bare their arm and insert their arm into cuff 23. FIG. 5 shows a similar device. In FIG. 5, cuff 78 attaches lower on the arm at the forearm area. Cuff 78 might be quicker and easier to attach for people in a hurry. While the sensors in the cuff are monitoring and recording the individual's physiological signs, the individual is asked to look directly at iris scanner 3 an iris scan is taken. The procedures as described above are then followed to determine if there are any physiological abnormalities.

Utilizing the process described above, an individual's abnormal physiological results can be identified. Also, a positive identification, and a baseline for future encounters can be created. Additionally, an international database easily accessed via the internet can be created. This gives security enforcers the ability to spot problem individuals before they can board an airplane, enter a courthouse, or anywhere there are security risks.

### System Components

As explained above, scanning system 1 is made up of three main components: 1) physiological sensors and supporting software, 2) iris scanner and recording and 3) ID card reader and boarding pass reader.

### Physiological Sensors and Supporting Software

As explained above, the physiological sensors measure parameters such as heart rate, electro cardiogram ECG, respiratory rate and effort, skin temperature, and galvanic skin response. In the preferred embodiments described above, main computer 4 is programmed to compare recorded physiological data transmitted from computer 13 to baseline values. Computer 13 then automatically assigns a pass or fail grade to the individual being scanned. Computer 13 alerts the operator of scanning system 1 that the physiological responses are not within the range and further inspection is needed.

### Iris Scanner and Recording

As explained above, iris scanner 3 scan's the individual's iris. The iris scan is included with the individual's file which also includes the sensory data and the recording of the boarding pass and identification card. This creates a complete identification of the individual to be entered into a database for future comparisons. A preferred iris scanner with associated software is available from the Sarnoff Corporation with offices in Princeton, N.J.

### ID Card Reader and Boarding Pass Reader

In a preferred embodiment, an individual desiring to enter a secure area is required to show an ID Card. If the secure area is for the purpose of transportation (i.e., airport, ship terminal, train depot) the individual is required to present his boarding pass. As explained above, scanner system 1 includes identification card scanner 7 and boarding pass scanner 6. The individual's identification card and boarding pass are readable by identification card scanner 7 and boarding pass scanner 6. As explained above, the information gathered by identification card scanner 7 and boarding pass scanner 6 is compiled with information from iris scanner 3 and physiological sign scanning device 2 for interpretation at main computer 4. The procedures as described above are then followed to determine if there are any physiological abnormalities. The operator at system scanner 1 is then alerted as appropriate.

Although the above-preferred embodiments have been described with specificity, persons skilled in this art will recognize that many changes to the specific embodiments disclosed above could be made without departing from the spirit of the invention. Therefore, the attached claims and their legal equivalents should determine the scope of the invention.

What is claimed is:

1) A security system for determining if a screened individual is a potential perpetrator of a crime, comprising:
A) a scanning system control computer,
B) a physiological sign scanning device connected to said scanning system control computer, said physiological scanning device for measuring at least one physiological sign of the individual,
C) a iris scanner connected to said scanning system control computer, said iris scanner for scanning the individual's iris,
D) an identification card scanner connected to said scanning system control computer, said identification card scanner for scanning the individual's identification card, and
E) a master computer connected to said scanning system control computer, said master computer comprising a hard drive, comprising:
1. a general population database of baseline normal values of physiological signs and vital signs for the general population, and
2. an individual database of baseline normal values for previously scanned individuals,
wherein said scanning system computer is programmed to receiving scan inputs from said physiological sign scanning device, said iris scanner, and said identification card scanner and to forward said scan inputs to said master computer, wherein said master computer is programmed to compare said scanned inputs to said general population database and said individual database and assign a grade of either a pass or fail to said scan inputs, wherein said master computer is programmed to transmit an alert to said scanning system control computer if said grade is a fail.

2) The security system as in claim 1, further comprising a boarding pass scanner connected to said scanning system control computer, said boarding pass scanner for scanning the individual's boarding pass.

3) The security system as in claim 1, wherein said scanning system control computer is connected to said master computer via the Internet.

4) The security system as in claim 1 wherein said at least on physiological sign comprises at least one vital sign.

5) The security system as in claim 1, wherein said individual database and said general population database is the TSA database.

6) The security system as in claim 1, wherein said physiological sign scanning device includes:
A) a blood pressure monitor,
B) a heart rate monitor,
C) a respirometer,
D) a body temperature monitor,
E) an EKG, and
F) an electro-dermal screening machine.

7) The security system as in claim 1, wherein said physiological sign scanning device is attached to the body of the individual, wherein said physiological sign scanning device comprises a plurality of plurality for detecting at least one physiological or vital sign.

8) The security system as in claim 4, wherein said physiological sign scanning device is a cuff comprising at least one physiological sensor.

9) The security system as in claim 8, wherein said cuff is attached to the user's forearm.

10) The security system as in claim 1 wherein said at least one physiological sign comprises:
A) blood pressure,
B) heart rate,
C) respiratory rate,
D) body temperature,
E) electrical impulses associated with cardiac contraction and relaxation of the individual's heart, and
F) galvanic skin response.

7) security system as in claim 1 wherein said at least one physiological sign comprises:
A) blood pressure,
B) heart rate,
C) respiratory rate,
D) body temperature,
E) electrical impulses associated with cardiac contraction and relaxation of the individual's heart, and
F) galvanic skin response.

11) The security system as in claim 1, wherein said master computer is programmed to:
A) compare said scanned inputs to values in said individual database and look for a match by comparing scanned data from said identification card,
B) transmit an alert if said scanned inputs receive a grade of fail after comparing to said individual database,
C) compare said scanned inputs to values in said general population database, and
D) transmit an alert if scanned inputs receive a grade of fail after comparing to said general population database.

12) The security system as in claim 1, wherein said master computer is further programmed to update said individual database with said scanned inputs by adding additional data to an individual with previous data entry and by adding new data to an individual with no previous data entry.

13) The security system as in claim 1, wherein said master computer is programmed to:
A) receive said scanned inputs,
B) check said individual database to see if there is an existing personal file for the individual being tested,
C) compare the individual's scanned inputs to the individual database if there is an existing personal file,
D) verify the individual's identity by checking the iris data and the identification card data,
E) verify the individual's physiological state by checking values in the existing personal file,
F) transmit an alert if scanned inputs receive a grade of fail after comparing to said existing personal file,
G) compare the individual's scanned inputs to the general database if there is no existing personal file,
H) transmit an alert if scanned inputs receive a grade of fail after comparing to said general database,
I) create a new personal file if there is no existing personal file,
J) record said iris scan data, said identification card scan data, and said physiological data.

14) The security system as in claim 1, wherein said master computer is programmed to:
A) ask the database if there's a personal file for this individual,
B) if not, compare individual data collected to universal norm, while setting up an individual file,
C) record iris scans, scanned ID, and physiological data,
D) if there is an individual file in the database verify identity, compare physiological baseline with present state.
